(19) United States
(12) Patent Application Publication
(10) Pub. No.: US 2026/0012126 A1
(43) Pub. Date: Jan. 8, 2026

(54) SNAP-IN BRACKET FOR INSTALLATION OF SOLAR MODULES ON TRACKER

(71) Applicant: APA SOLAR, LLC, Ridgeville Corners, OH (US)

(72) Inventors: Josh Von Deylen, Bryan, OH (US); Joseph Von Deylen, Whitehouse, OH (US); Shawn Jeremy Ramey, Ney, OH (US); Richard Alan Roth, Archbold, OH (US); Erik Steven Shinabery, Bryan, OH (US)

(21) Appl. No.: 19/261,071

(22) Filed: Jul. 7, 2025

Related U.S. Application Data
(60) Provisional application No. 63/667,943, filed on Jul. 5, 2024.

(51) Int. Cl. H02S 20/32; F16B 7/04

(52) U.S. Cl. CPC H02S 20/32; F16B 7/0493

(57) ABSTRACT

A solar module mounting features a solar module bracket comprising an elongate central panel with a pair of clip portions disposed on opposing ends that collectively define channels for receiving back rails of solar panel modules. Each clip portion includes an attachment portion with a retention tab and an opening configured to receive locking pins that secure the solar panel modules within the bracket. The locking pins are formed from unibody construction with spaced-apart arms and longitudinal splits, featuring locking tabs with downward projections for secure engagement with elongate slots in the back rails. The bracket includes a recessed mounting portion for attachment to tracker torque tubes via intermediate torque tube mounts using U-bolts and fasteners.

### CROSS-REFERENCE TO RELATED APPLICATIONS

This application claims the benefit of U.S. Provisional Application No. 63/667,943, filed on Jul. 5, 2024. The entire disclosure of the above application is incorporated herein by reference.

### FIELD

The present technology relates to solar energy systems and, more particularly, to apparatuses and methods for mounting solar modules onto tracking systems.

### INTRODUCTION

This section provides background information related to the present disclosure which is not necessarily prior art.

Solar module mounting systems can secure photovoltaic panels while accommodating tracking system requirements and diverse installation conditions. However, certain mounting approaches present several fundamental problems that limit solar installation effectiveness. Installation complexity can create operational challenges. A mounting system requires alignment and manual labor to achieve proper stability and performance, making installation time-consuming and costly. The rigid nature of these systems accelerates mechanical wear, necessitating frequent maintenance to preserve functionality.

Environmental adaptability remains problematic across varying terrain and conditions. Certain systems struggle to accommodate uneven ground while maintaining optimal panel orientation, resulting in reduced energy capture as panels cannot adjust to maximize solar exposure throughout operational cycles. Mechanical reliability issues plague existing clip-based mounting mechanisms. Integration difficulties with tracking technologies compound these problems. Complex mechanisms required for solar tracking functionality are prone to failures and require substantial maintenance investments, limiting practical deployment in cost-sensitive applications.

Accordingly, there is a continuing need for an improved solar module mounting system and method that addresses these challenges and offers enhanced adaptability to various installation environments, ease of installation and maintenance including reduced installation time and minimized risk of dislodgement under load, and robust integration with solar tracking technologies.

### SUMMARY

In concordance with the instant disclosure, an improved solar module mounting system and method that offers enhanced adaptability to various installation environments, ease of installation and maintenance including reduced installation time and minimized risk of dislodgement under load, and robust integration with solar tracking technologies has surprisingly been discovered.

In one embodiment, a solar module bracket for mounting a solar panel module having a back rail can include an elongate central panel with a pair of clip portions disposed on opposing ends of the elongate central panel. Each clip portion can include a pair of side walls extending orthogonally from the elongate central panel, wherein the elongate central panel and the pair of side walls collectively define a channel configured to receive a portion of the back rail of the solar panel module. Each clip portion can include an attachment portion having a retention tab and an opening, wherein an edge of the retention tab is cut out from a side wall, and wherein the opening has a shape that corresponds to elongate slots in the back rail. The opening can include extensions that extend from a surface of the side wall adjacent opposing lengths of the opening. A locking pin can be disposed in the elongate slots of the back rail of the solar panel module, with the locking pin configured to be received through the opening of the clip portion upon a relative lateral movement of the back rail in the channel of the solar module bracket to secure the solar panel module to the bracket. This configuration can provide enhanced structural stability and load distribution across the back rail while enabling the dual clip engagement functionality where the locking pin is pre-positioned in the back rail before the bracket engagement, facilitating the controlled lateral sliding motion that aligns the dual clip engagement system.

In another embodiment, a solar panel installation system can include a tracker torque tube, an intermediate torque tube mount secured to the tracker torque tube, and a solar module bracket mounted to the intermediate torque tube mount. The solar module bracket can include an elongate central panel with clip portions having attachment portions with retention tabs and openings. A solar panel module having a back rail with elongate slots can be positioned within the channels of the clip portions, and locking pins can be pre-installed through the elongate slots in the back rail. The solar module bracket can be laterally slid along the back rail until the locking pins are positioned within the openings of the attachment portions, thereby securing the solar panel module to the system through the dual clip engagement mechanism. This system configuration can accommodate multiple solar panel modules on a single tracker torque tube while maintaining the structural advantages of the unified mounting body design.

In a further embodiment, a method for mounting a solar panel module in a solar panel installation can include providing a tracker torque tube and an intermediate torque tube mount configured to be mounted on the tracker torque tube. The method can include providing a solar module bracket having an elongate central panel with a pair of clip portions disposed on opposing ends, each clip portion including an attachment portion with a retention tab and an opening. The method can include providing a solar panel module having a back rail with elongate slots and providing locking pins configured to engage with a dual clip engagement system. The installation process can include securing the intermediate torque tube mount to the tracker torque tube, mounting the solar module bracket to the intermediate torque tube mount, inserting the locking pins into the elongate slots of the back rail, placing the solar module bracket on the back rail, and laterally sliding the bracket along the back rail until the locking pins are positioned within the openings of the attachment portions. This method can ensure that the locking pins are pre-positioned and secured within the back rail before the bracket is engaged, facilitating a controlled lateral sliding motion that aligns the dual clip engagement system.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of a bracket for solar modules;

FIG. 2 is a bottom perspective view thereof;

FIG. 3 is a front elevational view thereof;

FIG. 4 is a right-side elevational view thereof;

FIG. 5 is a left-side elevational view thereof;

FIG. 6 is a bottom plan view thereof;

FIG. 7 is an environmental perspective view of the bracket shown installed with a solar panel;

FIG. 8 is an exploded environmental perspective view thereof;

FIG. 9 is an enlarged perspective view of the bracket mounted onto a torque tube;

FIG. 10 is perspective view of the bracket and a locking pin according to one embodiment of the present disclosure;

FIG. 11 is a perspective view of a locking pin for the bracket; and

FIGS. 12A-12B is a flow chart depicting a method of installing the bracket according to one embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

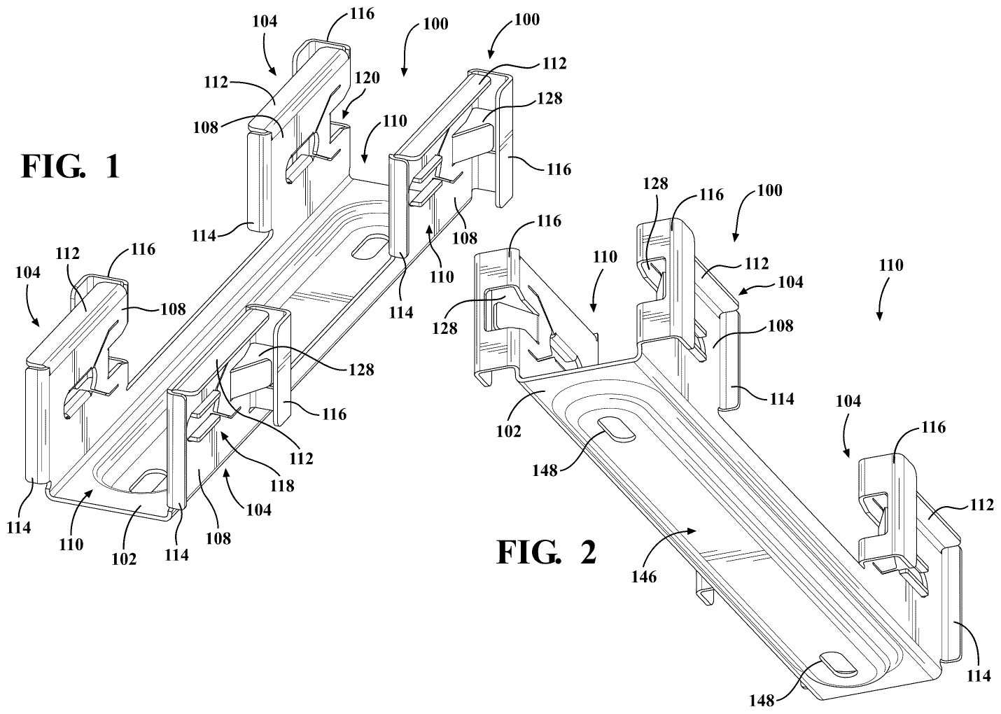

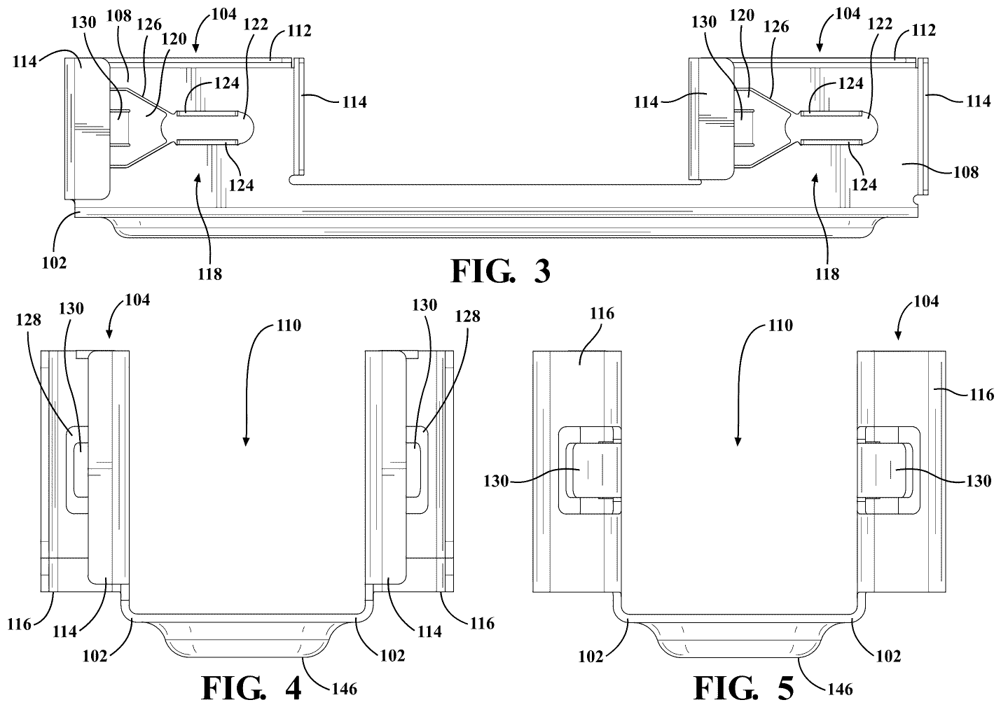

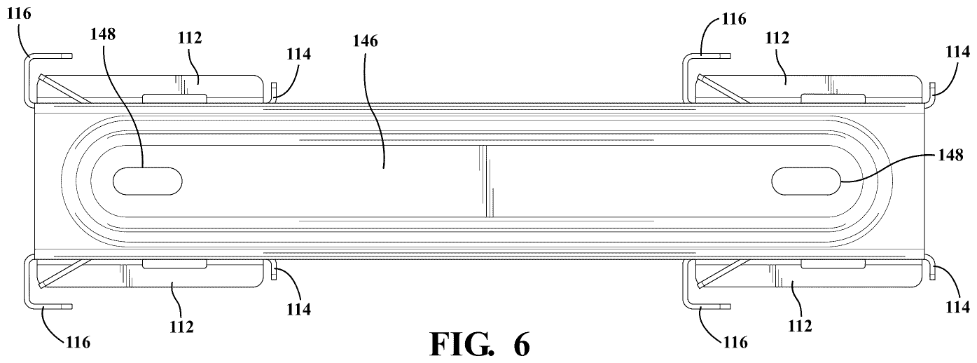

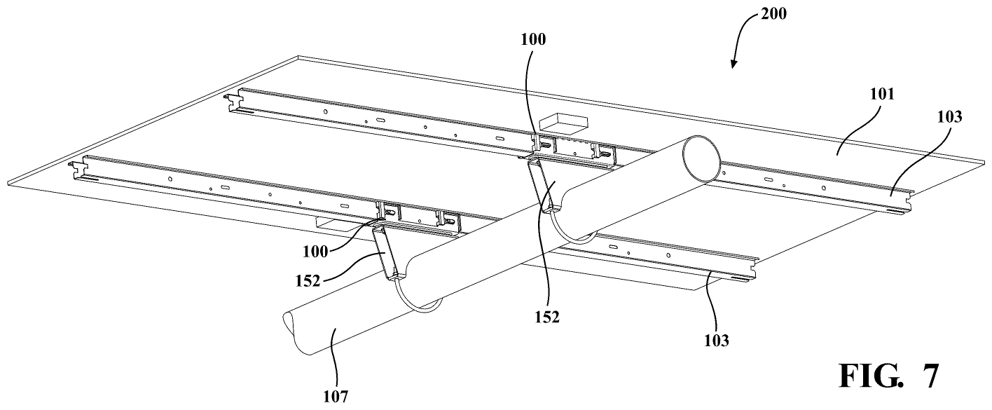

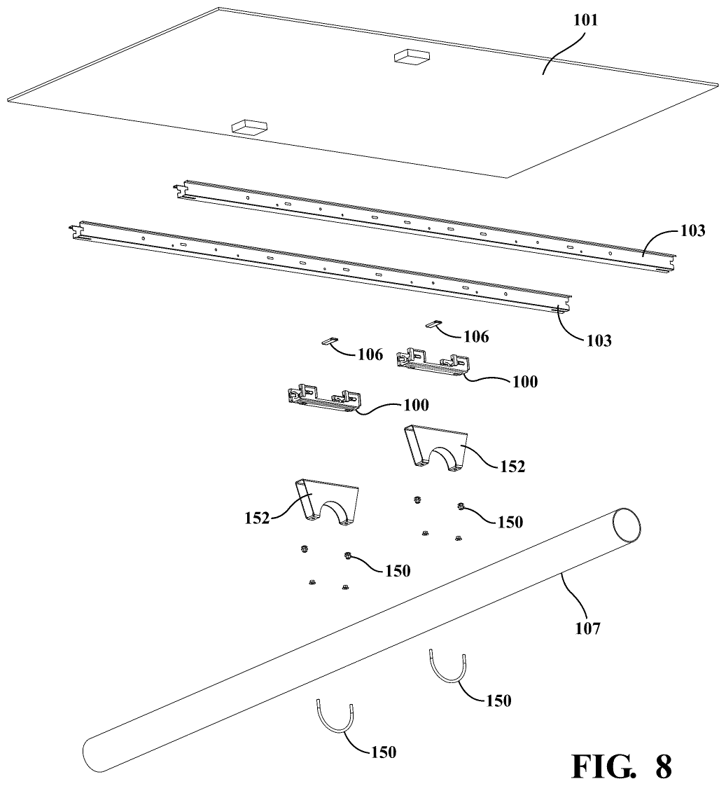

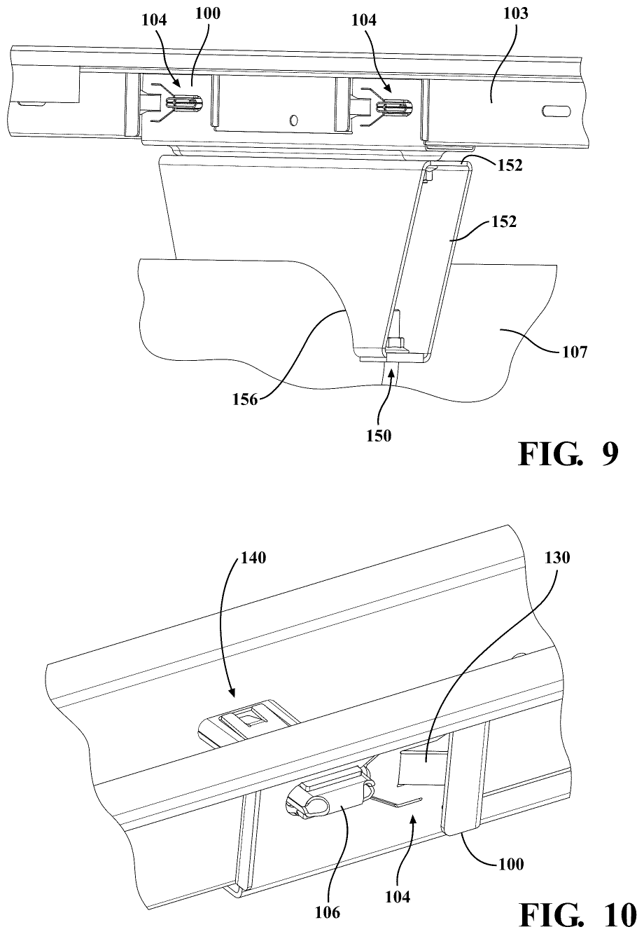

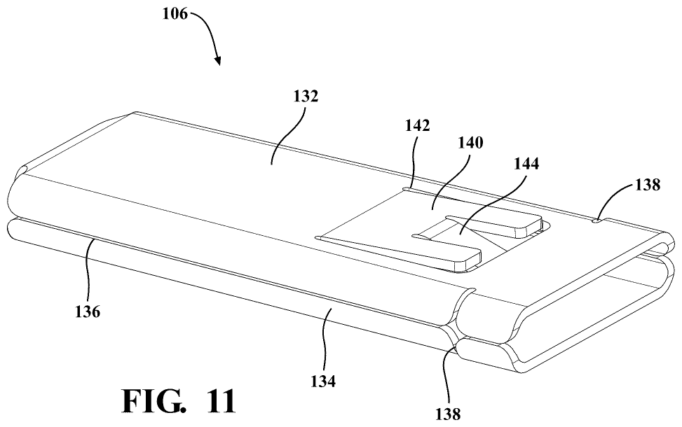

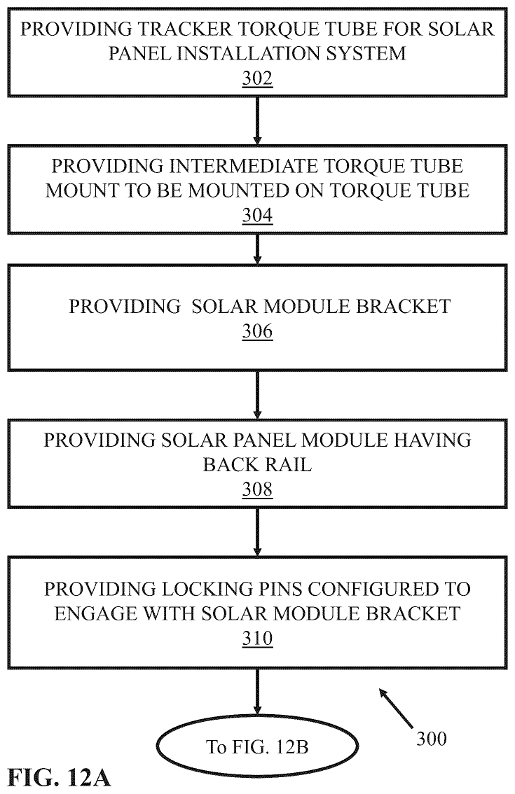

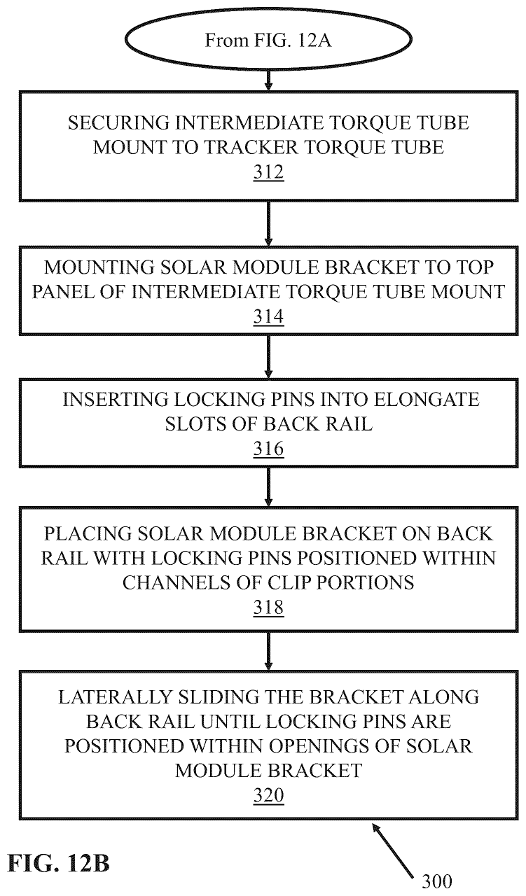

With reference to FIGS. 1-12, a solar module bracket 100 is shown. The solar module bracket 100 can be configured for mounting a solar panel module 101 in a solar panel installation with one or more torque tubes. The solar panel module 101 can include a back rail 103 that can serve as mounting points to secure the back of the solar panel module 103 to the solar module bracket 100. The back rail 103 can include one or more elongate slots 105 that facilitate engagement with the solar mounting brackets 100 and hardware. In some embodiments, the elongate slots 105 can be formed through the back rail 103, which can provide flexibility in positioning and alignment during installation while maintaining secure attachment to the solar module bracket 100. A skilled artisan can select a suitable configuration for the elongate slots within the scope of the present disclosure.

The solar module bracket 100 can be constructed from durable materials suitable for continuous exposure to environmental elements encountered in outdoor solar installations. In some embodiments, the solar module bracket 100 can be formed from corrosion-resistant materials that maintain structural integrity and functionality over extended operational periods. The material selection can ensure that the solar module bracket 100 withstands various weather conditions, temperature fluctuations, and environmental stresses while maintaining secure engagement with the back rail of the solar panel module. Additionally, the solar module bracket 100 can be coated with a protective finish to enhance durability and reduce wear from environmental exposure, thereby extending the operational lifespan of the solar module bracket 100.

The solar module bracket 100 can include an elongate central panel 102. A pair of clip portions 104 can be disposed on each end of the elongate central panel 102. Each clip portion 104 can form a U-shaped channel to receive the back rail 103 of the solar panel module 103. Furthermore, each clip portion 104 can be configured to engage with a locking pin 106 disposed in the elongate slots 105 in the back rail 103 of the solar panel module 101 as described in greater detail herein. The clip portions 104 can extend from the elongate central panel 102 and can collectively provide a mounting interface that can receive the back rail 103 of the solar panel module 101 and also facilitate an attachment of the solar panel module 101 to a torque tube 107 of a solar installation. The clip portions 104 can interface with the locking pin 106 to secure the back rail 103 of the solar panel module 101 to the solar module bracket 100. The locking pin 106 can be inserted through the elongate slots 105 in the back rail 103 and then the back rail 103 can be inserted into the channel of the solar module bracket 100 and moved laterally along the length of the back rail 103 to cause the locking pin 106 to engage the clip portions 104 and create a mechanical connection that secures the solar panel module 101 to the bracket 100.

The clip portions 104 can be separated along a length of the elongate central panel 102 to provide enhanced structural stability and load distribution across the back rail 103 of the solar panel module 101. This configuration can create a unified mounting body that can be more securely attached to the torque tube 107 compared to separately mounting two or more individual brackets. The elongate central panel 102 can provide structural continuity between the clip portions 104, reducing potential weak points that might otherwise exist between separate mounting components. The separation distance between the clip portions 104 can correspond to the spacing of the elongate slots 105 in the back rail 103, ensuring proper alignment during installation while distributing mounting forces over a greater span of the back rail 103 rather than concentrating loads at a single point. The unified design can enhance resistance to bending moments and torsional forces that might otherwise cause misalignment or failure, while the elongate central panel 102 can provide a substantial mounting interface with the torque tube 107 that distributes mounting stresses across a larger contact area.

Each clip portion 104 can include a pair of side walls 108 disposed along opposing edges of the elongate central panel 102, with each side wall 108 extending orthogonally from the elongate central panel 102. The elongate central panel 102 and the pair of side walls 108 can collectively define a channel 110 that can be configured to receive a portion of the back rail 103 of the solar panel module 101. The orthogonal configuration of the side walls 108 can provide structural support and guidance for the back rail 103 during installation, ensuring proper alignment and engagement with the elongate slots 105 and the associated locking pin 106 disposed therein. The channel 110 can be dimensioned to accommodate the cross-sectional profile of the back rail 103, allowing the solar panel module 101 to be positioned securely within each clip portion 104.

Each side wall 108 can include a top flange 112 extending orthogonally from a top edge of the side wall 108. The top flange 112 can be perpendicular to the respective side wall 108 and can abut a portion of the back rail 103 where the clip portion 104 is engaged on the back rail 103 of the solar panel module 101. Additionally, each side wall 108 can include side edge flanges extending outwardly from the side edges of the side wall 108. The top flange 112 can help with structural integrity by distributing the weight and mounting forces of the solar panel module 101 across multiple contact points rather than concentrating the load at one particular spot on the side walls 108. The flanges can provide additional bearing surface area that can enhance the overall stability and load distribution of the clip portion 104.

Each side wall 108 can include a front edge and a rear edge. The rear edge can have a perpendicular flange 114 extending outwardly therefrom, while the front edge can have a relatively larger L-shaped flange 116 extending outwardly therefrom. The larger L-shaped flange 116 at the front edge can provide enhanced structural integrity and load-bearing capacity in the area adjacent to a cut-out portion 128 of the side wall 108 that is discussed in greater detail herein. The larger L-shaped flange 116 can compensate for the reduced structural material in the cut-out region by providing additional surface area and reinforcement where the side wall 108 can experience weakening due to the material removal as compared to the perpendicular flange 114.

Each clip portion 104 can include an attachment portion 118 configured to engage the locking pin 106 disposed in the elongate slots 105 of the back rail 103. Each attachment portion 118 can include a retention tab 120 and an opening 122. The opening 122 can include extensions 124 that extend from the side wall 108 along opposing sides of the opening 122. The extensions 124 can assist with lateral placement of the solar module bracket 100 by providing guidance surfaces that ensure the opening 122 is properly aligned with the locking pin 106 during installation. This alignment functionality can facilitate precise positioning of the clip portions 104 relative to the elongate slots 105 in the back rail 103 of the solar panel module 101, ensuring that the locking pin 106 can be received through the opening 122 when aligned with the elongate slot 105 having the locking pin 106 disposed therein. The extensions 124 can create defined engagement surfaces that may guide the lateral movement of the solar panel module 101 in the channel 110 during the installation process, maintaining the dual clip engagement functionality while providing enhanced positioning accuracy for the permanent securement mechanism.

The retention tab 120 can be selectively movable to allow the solar module bracket 100 to engage the locking pin 106 on the back rail 103. The retention tab 120 can be configured to flex or deflect when the solar panel module 101 is positioned within the channel 110 and laterally moved to where an end of the locking pin 106 contacts and cause a deflection of the retention tab 120, enabling the back rail 103 to be locked within the clip portion 104.

The selective moveability of the retention tab 120 can be facilitated by an outside edge 126 being cut out from the side wall 108, along with the cutout 128 positioned adjacent to the L-shaped flange. The outside edge cutout 126 can provide flexibility at the perimeter of the retention tab 120, allowing it to deflect outwardly when the back rail 103 is inserted into the channel 110 and the ends of the locking pin 106 come in contact with the retention tab 120. The cutout 128 adjacent to the L-shaped flange can create a hinge point or pivot area that enables controlled movement of the retention tab 120 while maintaining structural integrity in the critical load-bearing region. This dual cutout configuration can allow the retention tab 120 to flex sufficiently to accommodate the back rail 103 and the locking pin 106 during initial engagement while ensuring that the L-shaped flange continues to provide the necessary structural reinforcement in the area where additional support is required. The combination of the outside edge cutout 126 and the adjacent cutout 128 can create a controlled deformation zone that facilitates the installation process without compromising the overall structural integrity of the clip portion 104.

To further aid the selective movement of the retention tab 120, the retention tab 120 can include an angled projection 130 that extends outwardly from the retention tab 120 toward the cutout 128 at an angle. The angled projection 130 can be configured to act as a ramp that contacts the ends of the locking pin 106 when the back rail 103 is slid laterally within the channel 110 of the solar module bracket 100. The angled projection 130 can provide mechanical advantage during installation by converting contact pressure from the locking pin 106 into outward movement of the retention tab 120, facilitating easier insertion of the ends of the locking pin 106 disposed in the back rail 103 into the openings 122 of the clip portion 104. The angled orientation can create a lever action that amplifies the force from the locking pin 106 while maintaining control over the movement of the retention tab 120. The angled projections 130 can be configured to contact the ends of the locking pin 106 disposed in the elongate slots 105 of the back rail 103 as the back rail 103 is slid laterally within the channel 110 of the solar module bracket 100. The contact with the ends of the locking pins 106 can cause the retention tab 120 to deflect and allow the locking pin 106 to move past the retention tab 120 where the ends of the locking pin 106 are received in the openings 122 and the retention tab 120 returns to an undeflected position to substantially lock the locking pin 106 and the associated back rail 103 in the solar module bracket 100. When combined with the outside edge cutout 126 and the cutout 128, the angled projection 130 can enable smooth and controlled deflection of the retention tab 120, allowing the back rail 103 to slide within the channel 110, and facilitating the receipt of the ends of the locking pin 106 in the openings 122 through the automatic snap-in engagement mechanism.

The locking pin 106 can be formed from a unibody construction that includes a first arm 132 and a second arm 134 that can be spaced apart from one another. A longitudinal split 136 can be formed by the spacing between the first arm 132 and the second arm 134, extending along the length of the locking pin 106. The width of the locking pin 106 can taper, being narrower at the connected end and wider at the open end, facilitating insertion into the opening 105 of the back rail 103 while providing secure engagement once positioned. Adjacent to the open end, there can be a locking edge 138 that, in the final assembly, can slot into the side wall 108 of the solar module bracket 100 at the opening 122, providing additional retention and preventing withdrawal of the locking pin 106 once fully received in the opening 122. The longitudinal split 136 can allow the first arm 132 and the second arm 134 of the locking pin 106 to be compressed together when pressure is applied during insertion through the opening 105 of the back rail 103 and/or the opening 122 and the elongate slots 105. The locking pin 106 can be self-biased so that when the locking pin 106 is not compressed, the locking pin 106 can automatically return to the expanded configuration due to the inherent spring properties of the material, with the first arm 132 and the second arm 134 returning to the spaced-apart positions. This expansion within the aligned opening 122 and elongate slots 105, combined with the locking edge 138 engagement, can create a secure mechanical connection that permanently secures the solar panel module 101 within the clip portion 104 through the dual clip engagement system.

The first arm 132 can include a locking tab 140 that can have a cut out edge 142. The locking tab 140 can include a downward projection 144 that can be cut out from the locking tab 140. This configuration can create a flexible locking tab 140 that can be pushed down during insertion of the locking pin 106 through the elongate slot 105 of the back rail 103, as the locking tab 140 can be able to flex due to the cut out edge 142. Once the locking pin 106 is positioned within the back rail 103, the locking tab 140 can automatically push up via the downward projection 144, thereby locking the locking pin 106 into the back rail 103. The downward projection 144 can provide a spring-loaded engagement mechanism that creates additional retention force beyond the expansion of the longitudinal split 136, ensuring that the locking pin 106 remains securely positioned within the dual clip engagement system. This locking tab 140 can complement the locking edge 138 engagement with the side wall 108 to provide multiple retention points that prevent withdrawal of the locking pin 106 once the solar panel module 101 is secured within the clip portion 104.

The installation process can begin with the locking pin 106 being first inserted into the elongate slots 105 of the back rail 103 of the solar panel module 101. The locking tab 140 can be compressed during insertion to allow the locking pin 106 to pass through the elongate slots 105, after which the downward projection 144 can automatically engage to secure the locking pin 106 within the back rail 103. Subsequently, the bracket 100 can be placed on the back rail 103 with the locking pins. The bracket 100 can then be laterally slid along the back rail 103 until the locking pins 106 engage the angled projections 130 of the retention tabs 120, causing the retention tabs to deflect and allow the bracket 100 to be further laterally slid along the back rail 103 until the ends of the locking pins 106 are received in the openings 122 of the attachment portions 118, thereby locking the bracket 100 onto the locking pins 106. This installation sequence can ensure that the locking pins 106 are pre-positioned and secured within the back rail 103 before the bracket 100 is engaged, facilitating a controlled lateral sliding motion that aligns the dual clip engagement system.

The elongate central panel 102 can include a mounting portion 146 that can be recessed in the elongate central panel 102 to allow for clearance for the fasteners 150 while not impairing the lateral sliding needed to lock the bracket 100 into place on the back rail 103. The recessed configuration can ensure that the fasteners 150 do not protrude above the surface of the elongate central panel 102, thereby maintaining a smooth profile that allows unobstructed lateral movement of the solar panel module 101 during the installation process. The mounting portion 146 can include apertures 148 that can receive fasteners 150 to secure the bracket 100 to a solar foundation. In one embodiment, the mounting portion 146 can allow the bracket 100 to be secured to a rail of a fixed tilt foundation.

In embodiments with a torque tube 107, the bracket 100 can be secured to an intermediate torque tube mount 152. The intermediate torque tube mount 152 can be generally trapezoidal in configuration with a top panel 154 that can receive the bracket 100. The top panel 154 can be approximately as long and as wide as the elongate central panel 102 of the bracket 100, providing a substantial mounting interface that distributes mounting stresses across the contact area. On the opposite end from the top panel 154, the intermediate torque tube mount 152 can include an arcuate portion 156 that can correspond to the torque tube 107, allowing the mount 152 to rest securely on the cylindrical surface of the torque tube 107. The intermediate torque tube mount 152 can include apertures that can flank the arcuate portion 156 and can receive the fastener 150, such as a U-bolt, to allow the mount 152 to be fastened to the torque tube 107.

It should be appreciated that a skilled artisan can select other suitable intermediate mounting structures to work with the bracket 100 based on the selected foundation. The intermediate torque tube mount 152 represents one embodiment of a mounting interface that can accommodate the recessed mounting portion 146 and fasteners 150 while maintaining the necessary clearance for lateral sliding functionality. Alternative intermediate mounting structures can be configured to interface with various foundation types, including different torque tube configurations, fixed tilt rail systems, ground mount foundations, or ballasted roof systems. The design considerations for the intermediate mounting can include ensuring that any selected intermediate mounting structure provides adequate support for the elongate central panel 102 while maintaining the recessed clearance that allows unobstructed lateral movement during the dual clip engagement process. The modular design of the mounting portion 146 with apertures 148 can accommodate various fastener configurations and mounting interfaces, allowing the bracket 100 to be adapted to diverse installation requirements while preserving the functionality of the clip portions 104 and locking pin 106 engagement system.

A solar panel installation system 200 can include one or more solar module brackets 100 configured for mounting solar panel modules 101 onto tracker torque tubes 107 or fixed tilt foundations. In the installed state, the intermediate torque tube mount 152 can be secured to the tracker torque tube 107 using a U-bolt disposed through the apertures that flank the arcuate portion 156. The solar module bracket 100 can be mounted to the top panel 154 of the intermediate torque tube mount 152 using fasteners 150 inserted through the apertures 148 in the recessed mounting portion 146 of the elongate central panel 102. The back rail 103 of the solar panel module 101 can be positioned within the channels 110 of the clip portions 104, with locking pins 106 pre-installed through the elongate slots 105 in the back rail 103. The solar module bracket 100 can be laterally slid with respect to the back rail 103 until the locking pins 106 are positioned within the openings 122 of the attachment portions 118, thereby securing the solar panel module 101 to the system 200.

Multiple solar module brackets 100 can be installed on a single tracker torque tube 107 to accommodate multiple solar panel modules 101 within the system 200, with the number of brackets determined based on the specific installation requirements and the length of the tracker torque tube 107. The modular design of the solar module bracket 100 can allow for flexible configuration of solar panel installations, where additional brackets 100 can be positioned along the length of the tracker torque tube 107 as needed to support the desired number of solar panel modules 101.

A method 300 for mounting a solar panel module 101 in a solar panel installation can include providing a tracker torque tube 107 and an intermediate torque tube mount 152 configured to be mounted on the tracker torque tube 107. The method 300 can include providing a solar module bracket 100 having an elongate central panel 102 with a pair of clip portions 104 disposed on opposing ends, each clip portion 104 including an attachment portion 118 with a retention tab 120 and an opening 122.

The method 300 can include a step 302 of providing a tracker torque tube 107 for the solar panel installation system. This step establishes the foundational mounting structure that will support the intermediate torque tube mount 152 and ultimately the solar module bracket 100. The tracker torque tube 107 can be positioned and secured according to the specific installation requirements, whether for tracking systems that follow solar movement or for fixed installations where tracking functionality is not required. Step 304 can include providing an intermediate torque tube mount 152 configured to be mounted on the tracker torque tube 107. The intermediate torque tube mount 152 can be generally trapezoidal in configuration with a top panel 154 that can receive the bracket 100 and an arcuate portion 156 that can correspond to the torque tube 107. The intermediate torque tube mount 152 can include apertures that can flank the arcuate portion 156 and can receive a U-bolt for fastening to the torque tube 107.

Step 306 can include providing a solar module bracket 100 having an elongate central panel 102 with a pair of clip portions 104 disposed on opposing ends. Each clip portion 104 can include an attachment portion 118 with a retention tab 120 and an opening 122. The elongate central panel 102 can include a recessed mounting portion 146 with apertures 148 that can receive fasteners 150 to secure the bracket 100 to the intermediate torque tube mount 152. Step 308 can include providing a solar panel module 101 having a back rail 103 with elongate slots 105 configured to receive locking pins 106. The back rail 103 can serve as the mounting interface for securing the solar panel module 101 to the bracket 100 through the dual clip engagement system.

Step 310 can include providing locking pins 106 configured to engage with the solar module bracket 100. Each locking pin 106 can be formed from a unibody construction with a first arm 132 and a second arm 134 spaced apart by a longitudinal split 136. The locking pins 106 can include locking tabs 140 with downward projections 144 and locking edges 138 for secure engagement. Step 312 can include securing the intermediate torque tube mount 152 to the tracker torque tube 107 using a U-bolt disposed through the apertures that flank the arcuate portion 156.

Step 314 can include mounting the solar module bracket 100 to the top panel 154 of the intermediate torque tube mount 152 using fasteners 150 inserted through the apertures 148 in the recessed mounting portion 146. The recessed configuration can ensure that the fasteners 150 do not protrude above the surface of the elongate central panel 102, thereby maintaining clearance for lateral sliding functionality. Step 316 can include inserting the locking pins 106 into the elongate slots 105 of the back rail 103. The locking tabs 140 can be compressed during insertion to allow the locking pins 106 to pass through the elongate slots 105, after which the downward projections 144 can automatically engage to secure the locking pins 106 within the back rail 103.

Step 318 can include placing the solar module bracket 100 on the back rail 103 with the locking pins 106 positioned within the channels 110 of the clip portions 104. The retention tabs 120 can provide temporary positioning during this initial placement phase. Step 320 can include laterally sliding the bracket 100 along the back rail 103 until the locking pins 106 are positioned within the openings 122 of the attachment portions 118 to secure the solar panel module 101 to the bracket 100 through the dual clip engagement system when the locking pins 106 are fully positioned within the openings 122.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A solar module bracket for mounting a solar panel module having a back rail, comprising:
an elongate central panel;
a pair of clip portions disposed on opposing ends of the elongate central panel, each clip portion including a pair of side walls extending orthogonally from the elongate central panel, wherein the elongate central panel and the pair of side walls collectively define a channel configured to receive a portion of the back rail of the solar panel module;
each clip portion including an attachment portion having a retention tab and an opening, wherein an edge of the retention tab is cut out from a side wall, and wherein the opening has a shape that corresponds to elongate slots in the back rail, the opening including extensions that extend from a surface of the side wall adjacent opposing lengths of the opening; and
a locking pin disposed in the elongate slots of the back rail of the solar panel module, the locking pin configured to be received through the opening of the clip portion upon a relative lateral movement of the back rail in the channel of the solar module bracket to secure the solar panel module to the bracket.

2. The solar module bracket of claim 1, wherein the clip portions are separated along a length of the elongate central panel.

3. The solar module bracket of claim 1, wherein each side wall includes a front edge having a perpendicular flange extending outwardly therefrom and a rear edge having a relatively larger L-shaped flange extending outwardly therefrom.

4. The solar module bracket of claim 3, wherein the larger L-shaped flange provides enhanced structural integrity and load-bearing capacity in an area adjacent to a cut-out portion of the side wall.

5. The solar module bracket of claim 1, wherein the retention tab is selectively movable to allow the bracket to engage the locking pin disposed in the elongate slots of the back rail.

6. The solar module bracket of claim 5, wherein the selective moveability of the retention tab is facilitated by an outside edge being cut out from the side wall and a cutout positioned adjacent to an L-shaped flange.

7. The solar module bracket of claim 6, wherein the retention tab includes an angled projection that extends outwardly from the retention tab toward the cutout at an angle, configured to contact ends of the locking pin as the back rail is slid laterally within the channel, wherein the contact with the ends of the locking pin causes the retention tab to deflect.

8. The solar module bracket of claim 1, wherein the locking pin is formed from a unibody construction including a first arm and a second arm spaced apart from one another by a longitudinal split.

9. The solar module bracket of claim 8, wherein a width of the locking pin tapers, being narrower at a connected end and wider at an open end.

10. The solar module bracket of claim 9, wherein adjacent to the open end there is a locking edge that slots into the side wall at the opening.

11. The solar module bracket of claim 8, wherein the first arm includes a locking tab having a cut out edge and a downward projection cut out from the locking tab.

12. The solar module bracket of claim 11, wherein the locking tab is configured to be pushed down during insertion of the locking pin through the elongate slots and automatically push up via the downward projection to lock the locking pin into the back rail.

13. The solar module bracket of claim 1, wherein the elongate central panel includes a mounting portion that is recessed in the elongate central panel to allow for clearance for fasteners while not impairing lateral sliding needed to lock the bracket into place on the back rail.

14. The solar module bracket of claim 13, wherein the mounting portion includes apertures that receive fasteners to secure the bracket to a solar foundation.

15. The solar module bracket of claim 1, further comprising an intermediate torque tube mount configured to be secured to a tracker torque tube, the intermediate torque tube mount being generally trapezoidal in configuration with a top panel that receives the bracket and an arcuate portion that corresponds to the tracker torque tube.

16. A solar panel installation system, comprising:
a tracker torque tube;
an intermediate torque tube mount secured to the tracker torque tube;
a solar module bracket according to claim 1 mounted to the intermediate torque tube mount;
a solar panel module having a back rail with elongate slots positioned within the channels of the clip portions; and
locking pins pre-installed through the elongate slots in the back rail, wherein the solar module bracket is laterally slid along the back rail until the locking pins are positioned within the openings of the attachment portions.

17. A method for mounting a solar panel module in a solar panel installation, comprising:
providing a tracker torque tube;
providing an intermediate torque tube mount configured to be mounted on the tracker torque tube;
providing a solar module bracket having an elongate central panel with a pair of clip portions disposed on opposing ends, each clip portion including an attachment portion with a retention tab and an opening;
providing a solar panel module having a back rail with elongate slots;
providing locking pins configured to engage with a dual clip engagement system;
securing the intermediate torque tube mount to the tracker torque tube;
mounting the solar module bracket to the intermediate torque tube mount;
inserting the locking pins into the elongate slots of the back rail;
placing the solar module bracket on the back rail; and
laterally sliding the bracket along the back rail until the locking pins are positioned within the openings of the attachment portions.

18. The method of claim 17, wherein inserting the locking pins includes compressing locking tabs during insertion and automatically engaging the locking tabs via downward projections to secure the locking pins within the back rail.

19. The method of claim 17, wherein the locking pins are pre-positioned and secured within the back rail before the bracket is engaged, facilitating a controlled lateral sliding motion that aligns the dual clip engagement system.

20. The method of claim 17, wherein the retention tabs provide temporary positioning during the lateral sliding process while final alignment of the locking pins with the openings creates a permanent mechanical connection.
